(19) United States
(12) Patent Application Publication
(10) Pub. No.: US 2026/0197348 A1
(43) Pub. Date: Jul. 9, 2026

(54) Decoy Icon-Based Application Access Control System with Conditional Replacement and Audit Notification

(71) Applicant: Jasmeet Singh Malhotra, Sterling, VA (US)

(72) Inventor: Jasmeet Singh Malhotra, Sterling, VA (US)

(21) Appl. No.: 19/546,363

(22) Filed: Feb. 22, 2026

Related U.S. Application Data
(60) Provisional application No. 63/878,068, filed on Sep. 8, 2025.

(51) Int. Cl. H04L 9/40

(52) U.S. Cl. CPC H04L 63/1491; H04L 63/08

(57) ABSTRACT

A system and method are disclosed for configurable application access control. An application-access-control element is presented on a computing device and associated with a protected application. Upon activation, a challenge-logic engine presents at least one authentication challenge and evaluates a user response against a correctness criterion. If the response satisfies the criterion, the protected application launches; if the response fails, a conditional-outcome handler executes an outcome selected from a group consisting of launching an alternate application, displaying media, disabling or hiding the protected application, or replacing the access-control element. An audit logger records each attempt, and a cloud-logging interface can transmit data to a remote server for centralized analysis and owner notification. The framework operates across smartphones, computers, smart televisions, automotive systems, AR/VR devices, and IoT platforms, with decoy icons as one exemplary embodiment.

### CROSS-REFERENCE TO RELATED APPLICATIONS

This application claims the benefit of U.S. Provisional Ser. No. 63/878,068, filed Sep. 8, 2025, entitled “Decoy Icon-Based Application Access Control System with Conditional Replacement and Audit Notification,” the entire disclosure of which is incorporated herein by reference.

### FIELD OF THE INVENTION

The present invention relates generally to computing-device security and user-interface customization. More particularly, it concerns systems and methods for controlling access to applications via configurable challenge logic and conditional outcomes based on authentication success or failure, with optional cloud-based logging and multi-platform implementations, wherein a decoy icon is one possible form of an application-access-control element.

### BACKGROUND OF THE INVENTION

Conventional application-locking mechanisms typically rely on static personal identification numbers (PINs), passwords, biometric authentication, or launcher-level restrictions. These approaches are visible, predictable, and limited to a single mode of authentication. They may be easily bypassed, especially in casual or shared-device scenarios where an unauthorized user can observe or replay a credential.

Existing solutions also lack flexible deterrents. When an incorrect credential is provided, the system usually just denies access, without any dynamic response that might mislead or delay an intruder. In addition, most provide no centralized auditability or multi-device logging for the owner.

There exists a need for a system that lets a device owner regulate access to one or more applications through configurable challenge logic capable of presenting cognitive or behavioural challenges as an additional or alternative gate beyond traditional credentials. When a challenge fails, the system should be able to perform conditional outcomes launching a decoy application, showing innocuous content, disabling the protected app, or replacing the access-control element while optionally producing local and cloud-based logs and notifying the owner.

Furthermore, such a system should function not only on smartphones but also across tablets, laptops, desktops, smart TVs, automotive infotainment units, augmented-and virtual-reality devices, and embedded IoT systems without privileged OS modifications. In at least some embodiments, a decoy icon in a launcher or menu is used as one implementation of the application-access-control element.

### PRIOR ART AND DISTINCTION

Certain prior systems, such as those described in U.S. Pat. No. 11,606,689 B1, authenticate application entry points but are limited to blocking or permitting application execution based on credential verification. Such systems do not provide multi-path post-failure behaviour, deception, or application substitution.

Other systems, including those disclosed in WO 2008/097191 A1, focus on non-invasive usage tracking and audit logging but lack interactive challenge logic, adaptive enforcement, and user-interface-level access substitution.

Further, enterprise authorization frameworks such as U.S. Pat. No. 9,058,471 B2 provide policy-based access control across heterogeneous environments but do not intercept application invocation events nor provide nonbinary outcomes following authentication failure.

Security systems utilizing deceptive authentication techniques, such as U.S. Pat. No. 11,979,395 B2, apply deception at a network session or token level, but do not operate at the local application launch interface, nor do they dynamically replace application access elements or launch alternate applications upon authentication failure.

Additionally, application data access management systems issued as U.S. Pat. No. 11,204,984 B2 regulate access to application data but do not provide challenge-based gating of application execution or conditional escalation behaviours. There is a need for advanced authentication logic, wherein the present invention introduces a configurable, modular framework.

### SUMMARY OF THE INVENTION

The present invention relates to computing-device security and user-interface customization. More particularly, it concerns systems and methods for controlling access to applications via configurable challenge logic in combination with conditional outcomes based on authentication success or failure, with optional cloud-based logging and multi-platform implementations, wherein a decoy icon is one possible form of an application-access-control element.

The present invention introduces a configurable, modular framework in which the decoy icon is one optional manifestation of an application access control element.

In one of the embodiments the present invention relates to authentication challenges, conditional outcomes, and logging operations being abstracted from the icon itself and can be dynamically defined, extended, and synchronized across multiple device categories. Thus, architecture enables cloud logging, remote owner control, and multi-platform deployment features.

In one of the embodiments, the present invention provides a configurable application access control system associating an access control element with a protected application.

In one of the embodiments the authentication challenge comprises a question, passphrase, gesture, sequence, timed interaction, or combination thereof.

In one of the embodiments the present invention relates to protected application with following steps:
i. Step 1, The application is activated, by a challenge logic engine presenting one or more authentication challenges, such as but limited to questions, gestures, orderings, or cognitive prompts.
ii. Step 2, after presenting one or more authentication challenges from Step 1, further, wherein the prompt is correctly responded, then the protected application is launched.
iii. Step 3, however, after presenting one or more authentication challenges from step1, if the prompts are incorrectly responded, then conditional outcome handler executes a single or combination of multiple activities such as but not limited to:
   a. launching an alternate application,
   b. displaying static or dynamic media,
   c. uninstalling, disabling, or hiding the protected application,
   d. replacing the access-control element with a placeholder or decoy, and
   e. applying escalation rules after repeated failures.

In one of the embodiments, the present invention relates to an authentication application in combination with audit logger configured to record access-attempt data including timestamps, identifiers, challenge type, and outcome following applications such as but not limited to:
i. access to all attempts,
ii. records all attempts,
iii. optionally, forward recorded attempts via a cloud-logging service to a remote server for centralized, tamper-resistant storage.

In one of the embodiments the present invention relates to application in combination with owner portal comprising following applications such as but not limited to:
i. aggregates logs from multiple devices,
ii. supports notifications and;
iii. allows security-policy management.

In one of embodiments the present invention relates to method application wherein the authentication agnostic platform can be operated with devices such as but not limited to:
i. smartphones,
ii. tablets,
iii. desktops,
iv. smart TVs,
v. automotive systems,
vi. AR/VR, and.
vii. IoT devices.
viii. computing device is selected from the group consisting of a smartphone, tablet, laptop, desktop computer, smart television, vehicle-infotainment system, augmented-reality device, virtual-reality device, and Internet-of-Things display.

In one of the embodiments the present invention relates to method of use wherein the authentication platform comprises but limited to:
i. to let a device owner regulate access to one or more applications through configurable challenge logic capable of presenting cognitive or behavioural challenge logic with alternative gate beyond traditional credentials.
ii. When a challenge fails, the system should be able to perform conditional outcomes launching a decoy application, showing innocuous content, disabling the protected app, or replacing the access-control element while optionally producing local and cloud-based logs and notifying the owner.

In one of the embodiments the present invention relates to a system for controlling access to an application on a computing device, comprising:
i. One or more processors
ii. a memory storing instructions

In one of the embodiments the present invention relates a memory storing instructions device with cloud-logging interface configured to transmit at least a portion of the access-attempt data to a remote server for centralized storage invention with applications such as but not limited to:
i. To present an application-access-control element associated with a protected application
ii. Invoke a challenge-logic engine in response to activation
iii. Evaluates response to one authentication logic against correctness criteria
iv. Launch a protected application or
v. Replacing the application-access-control element with placeholder.

In one of the embodiments the present invention relates to conditional outcomes including launching an alternate application, displaying a media element, disabling or hiding the protected application, or replacing the application-access-control element with an empty tile, alternate icon, or placeholder.

### BRIEF DESCRIPTION OF THE DRAWINGS

FIG. 1 relates to system architecture of the authentication application.

FIG. 2 relates to flowchart of user interaction

FIG. 3 relates to decision tree illustrating conditional outcomes on incorrect responses.

FIG. 4 relates to cloud-logging and owner-portal communication architecture across multiple devices and central server.

FIG. 5 relates to multi-platform deployment to devices.

FIG. 6 relates to multiple access-control elements.

### DETAILED DESCRIPTION OF THE INVENTION

The following detailed description enables any skilled person to make and use the invention. Specific embodiments are illustrative, not limiting.

FIG. 1: System architecture showing access control element manager, challenge logic engine, conditional-outcome handler, audit logger, notification dispatcher, and cloud-logging interface.

FIG. 1 illustrates an example system architecture for a configurable access-control system. The configurable access-control system operates on a user device (102) and includes one or more access-control elements (104) associated with respective applications. Interaction with an access-control element (104) generates an activation signal (106) that is received by an application access control element manager (108). The access-control element manager (108) invokes a challenge logic engine (112) configured to present one or more predefined challenges and to evaluate user input against stored criteria. Based on the evaluation result, the challenge logic engine (112) invokes a conditional outcome handler (114) to determine an access behavior. The conditional outcome handler (114) may permit execution of a protected application (120) or may execute an alternate outcome, including launching an alternate application, suppressing access behavior, modifying an access-control element (104), or displaying alternate content. The conditional outcome may further include generating conditional outcome event (122) and issuing one or more notifications (124) to a device owner, administrator, or monitoring service. In some embodiments, audit data is transmitted via a cloud logging interface (116) to a remote cloud server (126) for centralized monitoring, configuration management, or notification.

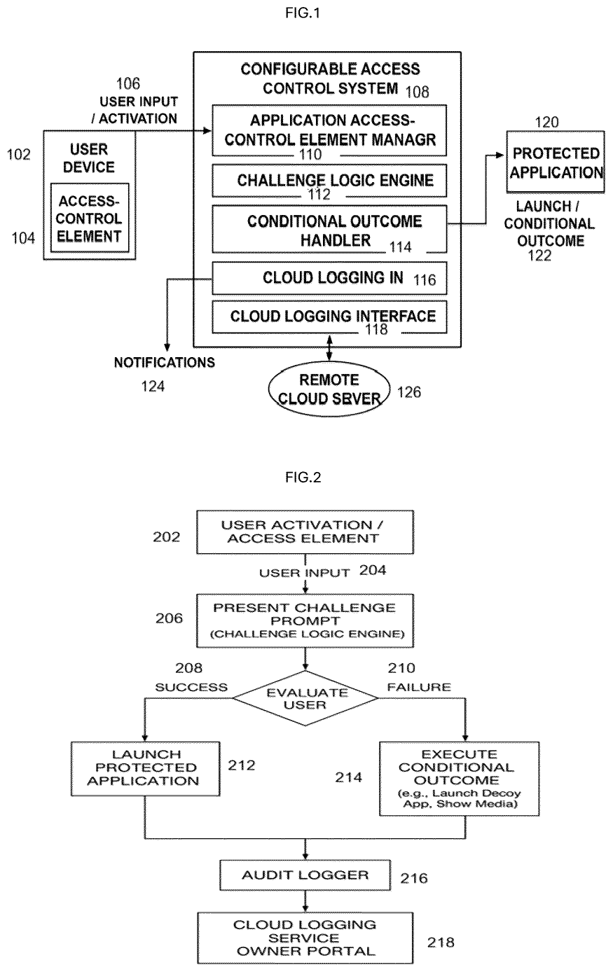

FIG. 2, a method for controlling access to a protected application is illustrated. A user activates an application-access-control (202) element. The system receives a corresponding user input (204). A challenge logic engine prompt (206) presents at least one authentication challenge. If the response satisfies or success (208) a correctness criterion, a success condition is determined, and the protected application is launched 212. However, if the response does not satisfy or failure (210) the correctness criterion, a failure condition is determined, and a conditional outcome (214) is executed. The conditional outcome may include launching an alternate application, displaying media content, restricting access, or performing another predefined action.

Following either outcome, an access-attempt record is generated by an audit logger (216), and the event data is transmitted to a cloud logging service and made available through an owner portal at step (218).

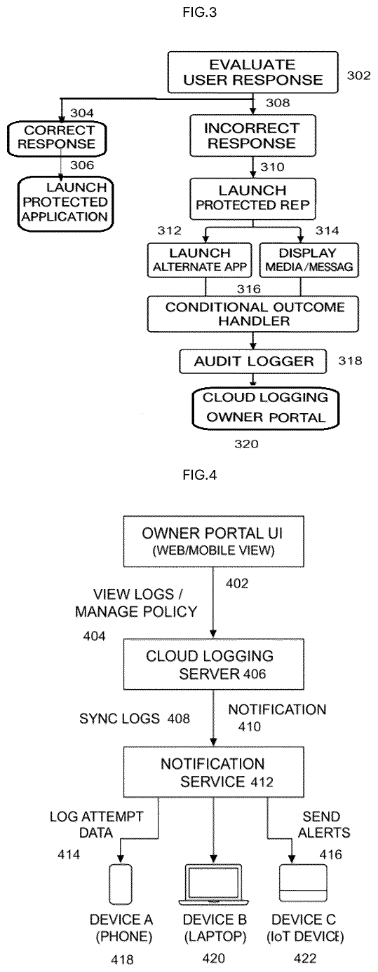

FIG. 3, a detailed flow for handling authentication outcomes is illustrated. At step 302, the system evaluates a user response to an authentication challenge (302). If the response satisfies a correctness criterion, a correct-response condition (304), and the protected application (306) is launched. If the response fails to satisfy the correctness criterion, an incorrect-response (308) condition is identified. In response, a conditional processing sequence is initiated at step (310). The conditional processing sequence may include one or more alternate actions. For example, an alternate or decoy application (312) may be launched. Alternatively, or additionally, media content or a message (314) may be displayed. The executed action is managed by a conditional outcome handler (316). The system records the event using an audit logger (318). The event data is transmitted to a cloud logging system (320) and made available through an owner portal.

FIG. 4 illustrates a cloud-logging and owner-portal architecture. An owner portal (402) allows viewing and management of logs stored in a cloud logging server (406). Access-attempt data (404) is transmitted from devices and synchronized (408) for centralized storage. A notification dispatcher (410) within the cloud environment cooperates with a notification service (412) to generate alert messages (416) based on recorded access events, predefined thresholds, or policy conditions. The cloud server aggregates logs from multiple devices (418), (420) and (422) and enables filtering, alert configuration, and policy management.

FIG. 5 illustrates multi-platform deployment across device types including smartphones, laptops, desktop computers, smart televisions, and AR/VR devices. Each platform runs a local challenge engine linked to a common cloud backend. In some embodiments, a centralized cloud system (502) manages synchronization of policies, logs, and configuration data (504) across multiple device types. Each device, including smartphones (506a), (506b), laptops (508a), (508b) desktop computers (510a), (510b), smart televisions (512a), (512b), and AR/VR or immersive devices (514a), (514b), executes a local challenge logic engine (516) configured to enforce access-control policies and communicate with the cloud system.

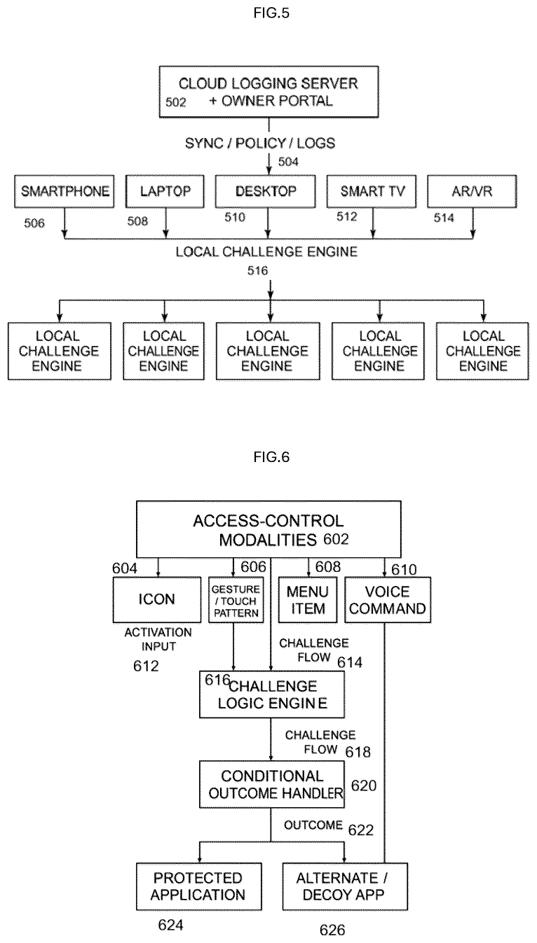

FIG. 6 illustrates multiple access-control modalities within a unified framework (602), wherein an activation input (612) initiates a challenge flow (614) executed by a challenge logic engine (616). Application-access-control elements may include graphical icons (604), gesture or touch patterns (606), menu selections (608), or voice commands (610). The resulting decision is processed through a conditional outcome handler (620) to produce an outcome (622), including launching a protected application (624) or an alternate or decoy application (626).

Further, in one of the embodiments the following definitions comprises such as:
i. Generic Access-Control Elements such as access elements include icons, menu entries, soft buttons, and voice commands. All invoke a shared challenge logic and conditional outcome framework.
ii. Implementation Considerations such as executable in software, hardware, or combination. Instructions reside on non-transitory media. The system may be a stand-alone app, OS module, or SDK. Icons, menus, or touch zones serve as triggers.

For purposes of this disclosure, the following terms are defined to clarify the scope of the invention. These definitions are provided for illustrative clarity and are not intended to limit the invention to the specific examples described.

“Application-access-control element” refers to any user-interface construct, trigger, or invocation mechanism associated with a protected application and configured to invoke authentication logic prior to application access. Non-limiting examples include graphical icons, launcher tiles, menu entries, widgets, buttons, touch zones, gesture triggers, voice commands, shortcuts, or combinations thereof.

“Protected application” refers to any software application, executable, service, or data-access interface whose execution or access is conditionally restricted by the system described herein.

“Challenge logic engine” refers to a software or hardware module configured to generate, present, manage, and evaluate one or more authentication challenges. The challenge logic engine may dynamically select challenges based on configuration rules, contextual parameters, or historical data.

“Authentication challenge” refers to any interactive prompt, task, or verification mechanism requiring a response from a user to determine authorization. Authentication challenges may include, without limitation, questions, passphrases, gestures, sequences, spatial interactions, timed inputs, behavioral patterns, or combinations thereof.

“Conditional outcome” refers to any action, state change, or response executed by the system as a result of an authentication evaluation. Conditional outcomes may be executed upon successful authentication, failed authentication, or repeated failures, and may include deceptive, deterrent, or escalation behaviors.

“Decoy application” refers to an alternate application, interface, or content presented in response to a failed authentication attempt, intended to misdirect, delay, or conceal the existence of the protected application.

“Audit logger” refers to a component configured to record access-attempt data, including but not limited to timestamps, device identifiers, challenge types, responses, outcomes, and escalation events.

“Cloud-logging interface” refers to a communication module configured to securely transmit audit data to a remote server for centralized storage, aggregation, analysis, or owner review.

“Owner portal” refers to a remote interface accessible by an authorized owner, administrator, or account holder, through which access logs, alerts, policies, and configuration settings may be viewed or managed.

“Escalation rule” refers to a predefined or adaptive rule that modifies system behavior after one or more failed authentication attempts, including altering challenge difficulty, changing conditional outcomes, disabling access elements, or issuing notifications.

### Example 1: Decoy Icon With Cognitive Challenge

In one exemplary embodiment, an application-access-control element comprises a graphical icon displayed in a launcher interface that visually resembles a benign application. Upon activation, the icon does not immediately launch the protected application but instead invokes the challenge logic engine.

The challenge logic engine presents a cognitive authentication challenge, such as a personalized question or ordered sequence of inputs. If the response satisfies the correctness criterion, the protected application launches seamlessly. If the response fails, a conditional outcome is executed, such as launching a decoy application displaying innocuous content, while the audit logger records the attempt.

In another embodiment, the challenge logic engine presents a sequence of multiple authentication challenges, such as a gesture followed by a timed interaction. Successful completion of all challenges results in application access.

Upon incorrect completion of one or more challenges, the conditional outcome handler may apply escalation rules, including increasing challenge complexity on subsequent attempts, temporarily hiding the access-control element, or disabling the protected application for a predetermined period.

### Example 2: Context-aware Challenge Selection

In some embodiments, predefined rules or thresholds may trigger alerts based on access frequency, timing, or repeated failures.

For example, access attempts occurring at unusual times or locations may trigger more complex challenges or stricter conditional outcomes, while routine access attempts may trigger simpler challenges.

### Example 3: Cloud Logging and Owner Notification

In another embodiment, the audit logger records all access attempts locally and transmits encrypted audit data via the cloud-logging interface to a remote server.

The owner portal aggregates logs across multiple devices and provides filtering, visualization, and alerting capabilities. Notifications may be generated in response to predefined events, such as repeated authentication failures or escalation triggers.

### Example 4: Cross-Platform Deployment

In one embodiment, the system is deployed across heterogeneous devices including smartphones, desktops, smart televisions, automotive infotainment systems, AR/VR devices, and IoT displays.

Each device executes a local instance of the challenge logic engine while synchronizing policies, logs, and updates with a centralized cloud backend, enabling consistent enforcement across platforms without requiring privileged operating-system modifications.

### Example 5: Non-Icon Access-Control Elements

In some embodiments, the application-access-control element is not a graphical icon but a menu entry, soft button, voice command, or gesture-based trigger. Regardless of form, activation invokes the same challenge logic and conditional outcome framework.

The foregoing examples are provided for purposes of illustration only. The invention is not limited to the specific embodiments described, and variations, combinations, and modifications may be made without departing from the scope of the appended claims.

1. A computing device configured to control access to a protected application, the computing device comprising:
a processor;
a memory storing instructions that, when executed by the processor, cause the computing device to:
(a) intercept a launch request associated with a protected application, including activation of an application-access-control element associated with the protected application;
(b) in response to the launch request, present an authentication challenge via a user interface;
(c) receive input corresponding to a response to the authentication challenge;
(d) evaluate the response against stored authentication data;
(e) when the response satisfies an authentication criterion, permit execution of the protected application; and
(f) when the response fails to satisfy the authentication criterion, prevent execution of the protected application and automatically launch a substitute interface in place of the protected application, the substitute interface being visually configured to simulate normal operation of the protected application.

2. The computing device of claim 1, wherein intercepting the launch request comprises detecting activation of an icon displayed within a launcher environment of the computing device.

3. The computing device of claim 1, wherein the substitute interface comprises a locally stored interface shell that mimics at least one visual characteristic of the protected application.

4. The computing device of claim 1, wherein the substitute interface is launched without presenting a notification indicating that access to the protected application has been denied.

5. The computing device of claim 1, wherein the substitute interface comprises one of:
an alternate application;
(a) a simulated interface instance;
(b) a media display; or(c) a placeholder graphical element.

6. The computing device of claim 1, further comprising an audit module configured to record access attempt data including at least one of:
i. a timestamp, ii. a challenge type, iii. an input identifier, or iv. an outcome indicator.

7. The computing device of claim 6, wherein the instructions further cause the computing device to transmit at least a portion of the access attempt data to a remote server.

8. The computing device of claim 7, wherein the remote server is configured to provide a management interface enabling configuration of authentication parameters and review of access attempt data.

9. A computer-implemented method for controlling access to a protected application on a computing device, the method comprising:
i. intercepting a launch request associated with the protected application;
ii. presenting an authentication challenge in response to the launch request;
iii. receiving a response to the authentication challenge;
iv. evaluating the response against stored authentication data;
v. permitting execution of the protected application when the response satisfies an authentication criterion; and
vi. preventing execution of the protected application and automatically launching a substitute interface when the response fails to satisfy the authentication criterion, the substitute interface being configured to simulate normal operation of the protected application.

10. The method of claim 9, further comprising recording access attempt data associated with the launch request.

11. The method of claim 9, wherein launching the substitute interface occurs without presenting a denial notification.
